(19) United States
(12) Patent Application Publication
(10) Pub. No.: US 2026/0204004 A1
(43) Pub. Date: Jul. 16, 2026

(54) APPARATUS FOR DETECTING CHANGE IN POINT OF INTEREST AND METHOD THEREOF

(71) Applicant: ELECTRONICS AND TELECOMMUNICATIONS RESEARCH INSTITUTE, Daejeon (KR)

(72) Inventors: Do Hun KIM, Daejeon (KR); Min Ho BAE, Daejeon (KR); Seong Hee LEE, Daejeon (KR)

(21) Appl. No.: 19/449,154

(22) Filed: Jan. 14, 2026

(30) Foreign Application Priority Data
Jan. 15, 2025 (KR) 10-2025-0006344

(51) Int. Cl. G06T 15/20; G06T 7/246; G06T 7/579; G06T 7/73; G06T 7/90; G06V 10/764

(52) U.S. Cl. CPC G06T 15/205; G06T 7/248; G06T 7/579; G06T 7/74; G06T 7/90; G06V 10/764; G06T 2207/10024; G06T 2207/10028; G06T 2207/20081; G06T 2210/56

(57) ABSTRACT

Provided are an apparatus and method for detecting a change in a point of interest (POI), and the apparatus for detecting a change in a POI includes: an input/output module that receives 3D point cloud data (PCD), PCD, optical images, and global positioning system (GPS) data from a LiDAR sensor, an optical camera, and a GPS receiver installed on a moving object and outputs a detection result; a database; and a processor operatively coupled to the input/output module and the database, wherein the processor is configured to generate a PCD map based on the 3D PCD input from the LiDAR sensor, receive a detection area within a POI and set the detection area on the PCD map based on the GPS data, collect the PCD from the LiDAR sensor, estimate a position of the moving object, and project the 3D PCD onto the optical image based on a distance between the position of the moving object and the detection area to visually provide a projection result, and analyze a degree of change in the detection area.

### CROSS-REFERENCE TO RELATED APPLICATION

This application claims priority to and the benefit of Korean Patent Application No. 10-2025-0006344, filed on Jan. 15, 2025, the disclosure of which is incorporated herein by reference in its entirety.

### BACKGROUND

### 1. Field of the Invention

The present invention relates to an apparatus for detecting a change in a point of interest and a method thereof.

### 2. Discussion of Related Art

The easiest and most convenient method of checking whether a moving object, such as a mobile robot or person, has properly arrived at an intended final destination is to use global positioning system (GPS) information.

However, in congested areas, such as urban environments in which navigation guidance for moving objects is required, situations frequently occur in which GPS information is not usable or is inaccurate due to shadowing effects and noise. Therefore, relying only on GPS information to determine whether a moving object has arrived at the final destination is insufficient, and it is required to use additional information in a complementary manner.

Among such additional information, the most commonly used type of information is an image (video), and representative images, such as the front or entrance of a point of interest (POI), may be acquired and used to estimate whether a moving object has arrived at the final destination.

Light Detection and Ranging (LiDAR) technology is widely utilized in various industrial fields, including autonomous driving, robotics, drone exploration, and 3D spatial recognition.

Such LiDAR is mainly used to generate PCD for 3D environment recognition, and based on this, autonomous vehicles, drones, and robots recognize the surrounding environment and determine movement routes in real time.

### SUMMARY OF THE INVENTION

Autonomous moving objects may use such LiDAR data to accurately identify the space in which they are located and rapidly respond to obstacle avoidance, route exploration, and environmental changes.

However, current autonomous moving object systems are mainly focused on route exploration or obstacle avoidance, and the function to monitor and manage a specific point of interest within a specific area is limited.

For example, on roads or at industrial sites, when a specific object is damaged or an environmental change occurs, continuous monitoring and maintenance have been mainly performed manually. As a result, the efficiency of monitoring decreases, and rapid response becomes difficult.

Accordingly, there are limitations in precisely monitoring a POI or tracking damaged parts in real time in autonomous moving object systems. In particular, when a change or damage occurs within a POI, visual check and immediate handling require a manager to physically access the site and directly observe it, leading to inefficiency.

Furthermore, point cloud data (PCD) collected by LiDAR, which is 3D spatial information, is not easily integrated with real-time image data, and therefore does not provide intuitive visualization.

The present invention is directed to providing an apparatus and method for detecting a change in a point of interest (POI) that are capable of monitoring a damaged area or specific object within a POI generated based on 3D PCD utilizing a LiDAR sensor mounted on a moving object, and detecting a change or damage in a detection area in real time.

According to an aspect of the present invention, there is provided an apparatus for detecting a change in a POI, which includes: an input/output module that receives 3D PCD, PCD, optical images, and global positioning system (GPS) data from a LiDAR sensor, an optical camera, and a GPS receiver installed on a moving object and outputs a detection result; a database; and a processor operatively coupled to the input/output module and the database, wherein the processor is configured to generate a PCD map based on the 3D PCD input from the LiDAR sensor, receive a detection area within a POI and set the detection area on the PCD map based on the GPS data, collect the PCD from the LiDAR sensor and estimates a position of the moving object, project the 3D PCD onto the optical image based on a distance between the position of the moving object and the detection area and visually provide a projection result, and analyze a degree of change in the detection area.

The processor may apply a simultaneous localization and mapping (SLAM) algorithm to generate the PCD map through the 3D PCD.

The processor may set the detection area to be visually distinguished according to a detection importance thereof.

The processor may match the PCD with the PCD map through SLAM feature matching when the moving object approaches a range within a set distance to the POI to estimate a current position of the moving object.

The processor may project the 3D PCD onto the optical image when the detection area is included in the optical image, to visualizes the 3D PCD.

The processor may classify a type of an object through a classification algorithm that has been trained on objects in the detection area and provides a result of the classification.

The processor may store pixel-based RGB values of the visualized optical image and pixel-based position coordinates of the 3D PCD in the database in time series, and analyze the degree of change in the detection area.

According to an aspect of the present invention, there is provided a method of detecting a change in a POI, which includes: generating, by a processor, a PCD map based on 3D PCD input from a LiDAR sensor; receiving, by the processor, a detection area within a POI and setting the detection area on the PCD map based on GPS data; collecting, by the processor, PCD from the LiDAR sensor and estimating a position of a moving object; projecting the 3D PCD onto an optical image based on a distance between the position of the moving object and the detection area and visually providing a projection result; and analyzing a degree of change in the detection area.

The generating of the PCD map may include applying, by the processor, an SLAM algorithm to generate the PCD map through the 3D PCD.

The setting of the detection area may include setting the detection area to be visually distinguished according to a detection importance thereof.

The estimating of the position of the moving object may include matching, by the processor, between the PCD and the PCD map through SLAM feature matching when the moving object approaches a range within a set distance to the POI to estimate a current position of the moving object.

The providing of a projection result visually may include projecting, by the processor, the 3D PCD onto the optical image when the detection area is included in the optical image, to visualize the 3D PCD.

The providing of a projection result visually may include classifying, by the processor, a type of an object through a classification algorithm that has been trained on objects in the detection area and providing the classified type of the object.

The analyzing of the degree of change in the detection area may include storing, by the processor, pixel-based RGB values of the visualized optical image and pixel-based position coordinates of the 3D PCD in a database in time series, and analyzing the degree of change in the detection area.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating an apparatus for detecting a change in a point of interest (POI) according to an embodiment of the present invention;

FIGS. 2A to 2E are exemplary diagrams for describing operations of an apparatus for detecting a change in a POI according to an embodiment of the present invention; and

FIG. 3 is a flowchart for describing a method of detecting a change in a POI according to an embodiment of the present invention.

### DETAILED DESCRIPTION OF EXEMPLARY EMBODIMENTS

Hereinafter, embodiments according to the present invention will be described. In this process, the thickness of each line or the size of each component shown in the drawings may be exaggerated for the purposes of clarity and convenience. Although terms used herein are selected from among general terms that are currently widely used in consideration of functions in the exemplary embodiments, these may be changed according to intentions or customs of those skilled in the art or the advent of new technology. Therefore, definitions of these terms should be made based on the content throughout this specification.

The implementations described herein may be implemented in, for example, a method or process, an apparatus, a software program, a data stream, or a signal. Even when only discussed in the context of a single form of implementation (for example, discussed only as a method), the implementation of discussed features may also be implemented in other forms (for example, an apparatus or program). An apparatus may also be implemented in appropriate hardware, software, and firmware. The methods may be implemented in, for example, an apparatus such as a processor, which is a general term for a processing device, such as a computer, a microprocessor, an integrated circuit, or a programmable logic device.

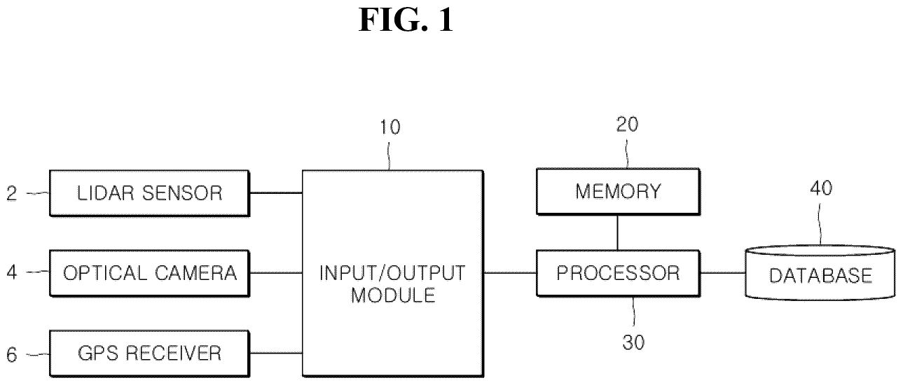

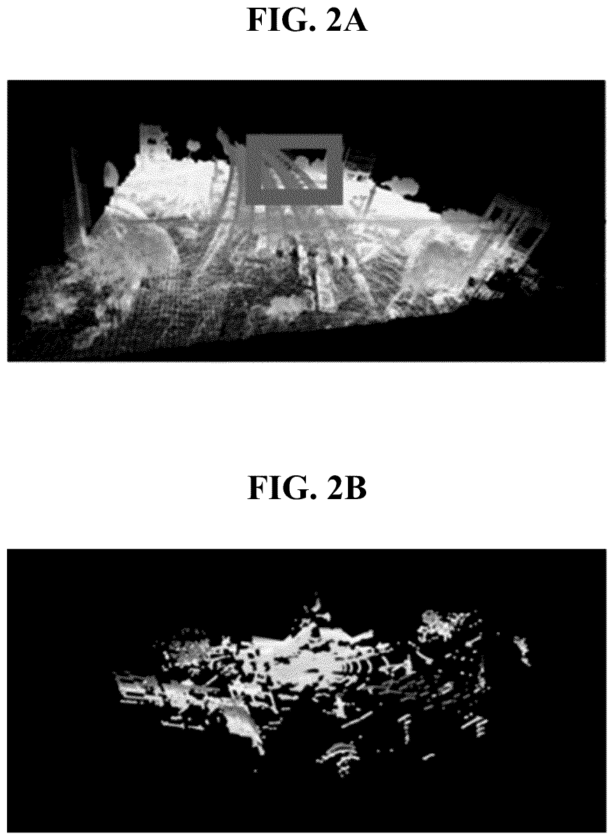

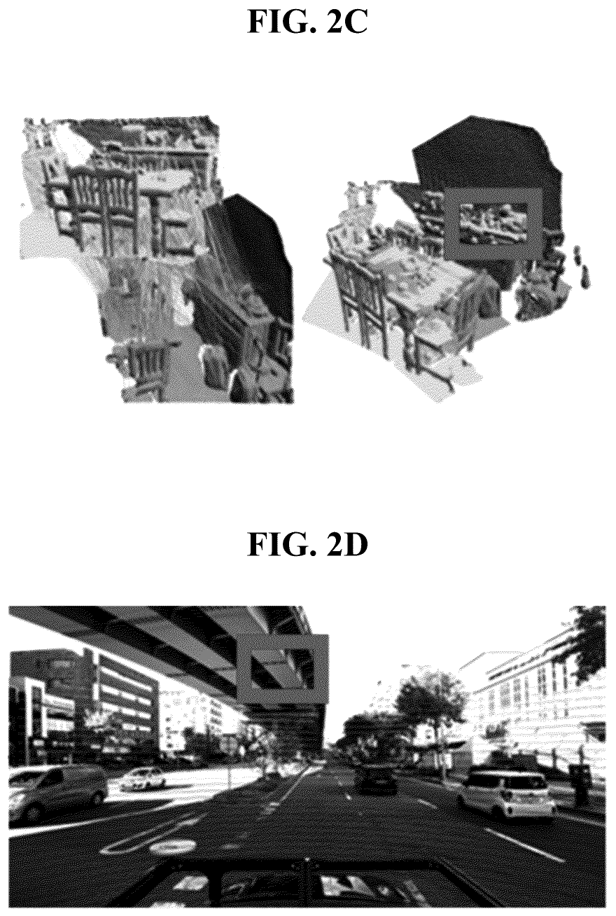

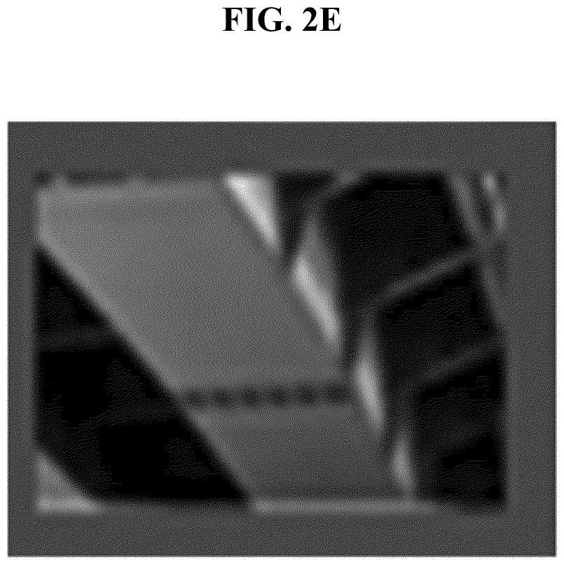

FIG. 1 is a block diagram illustrating an apparatus for detecting a change in a point of interest (POI) according to an embodiment of the present invention, and FIGS. 2A to 2E are exemplary diagrams for describing operations of an apparatus for detecting a change in a POI according to an embodiment of the present invention.

Referring to FIG. 1, an apparatus for detecting a change in a POI according to the embodiment of the present invention may include an input/output module 10, a database 40, a memory 20, and a processor 30.

The input/output module 10 may receive an input of 3D point cloud data (PCD), PCD, optical images, and global positioning system (GPS) data in a wired or wireless manner from a LiDAR sensor 2, an optical camera 4, and a GPS receiver 6 installed on a moving object and output detection results.

Here, the moving object may include a moving object capable of autonomous movement and may include an autonomous vehicle, a drone, a robot, and the like.

When the LiDAR sensor 2 and the optical camera 4 are mounted on the moving object, the LiDAR sensor 2 and the optical camera 4 may be calibrated such that coordinate systems of measured PCD and optical images may correspond to each other.

In addition, the input/output module 10 may be connected to a network as a device for user interface and may receive an input of setting values or commands for operating the apparatus for detecting a change in a POI. That is, a POI and detection areas to be set on a PCD map may be input to the input/output module 10.

For example, the input/output module 10 may include devices such as a microphone, a keyboard, or a mouse for input, and may include devices such as a display or a speaker for output. As another example, the input/output module 10 may include a device that integrates input and output functions, such as a touchscreen. In addition, the input/output module 10 may be configured as a single device such as a computer device.

Here, the 3D PCD input from the input/output module 10 is PCD collected by scanning the surrounding environment in three dimensions through the LiDAR sensor 2.

In addition, PCD is PCD collected in real time from the LiDAR sensor 2.

The database 40 may store a PCD map generated based on 3D PCD input from the LiDAR sensor 2, store a POI and a detection area set on the PCD map, and store pixel-based RGB values of an optical image visualizing the detection area and pixel-based position coordinates of the 3D PCD in time series.

In addition, the database 40 may store an analysis result of analyzing the degree of change in the detection area and may store a classification model of a classification algorithm trained on objects in the detection area.

The memory 20 may store execution programs and related data for the apparatus for a change in a POI, and the stored information may be selected by the processor 30 as needed.

That is, the memory 20 stores various types of data and commands generated during the execution of an operating system (O/S) or applications (programs or applets) for driving the apparatus for detecting a change in a POI. In this case, the memory 20 may be implemented as non-volatile memory, a volatile memory, a flash-memory, a solid state drive (SSD), or the like. In addition, the memory 20 may be accessed, and data may be read/recorded/modified/deleted/updated by the processor 30.

The processor 30 is operatively coupled to the input/output module 10, the memory 20, and the database 40, copies various programs stored in the memory 20 to RAM, and executes the programs to control the overall operation of the apparatus for detecting a change in a POI and perform various operations.

Although the processor 30 has been described as including only a single CPU, in implementation, it may be implemented with a plurality of CPUs (or DSPs, SoCs, etc.).

In various embodiments, the processor 30 may be implemented as a digital signal processor (DSP), a microprocessor, or a time controller (TCON) that processes digital signals. However, the processor 30 is not limited thereto, and the processor 30 may include or be defined as one or more of a central processing unit (CPU), a micro controller unit (MCU), a micro processing unit (MPU), a controller, an application processor (AP), a communication processor (CP), or an ARM processor. In addition, the processor 30 may be implemented as a system on chip (SoC) with embedded processing algorithms, a large scale integration (LSI), or in the form of a field programmable gate array (FPGA).

That is, the processor 30 may execute the execution program stored in the memory 20 and then receive 3D PCD, PCD, optical images, and GPS data measured by the LiDAR sensor 2, the optical camera 4, and the GPS receiver 6 installed on the moving object from the input/output module 10.

Afterwards, the processor 30 may receive 3D PCD scanned in three dimensions of the surrounding environment from the LiDAR sensor 2 and apply a simultaneous localization and mapping (SLAM) algorithm to generate a PCD map as shown in FIG. 2A.

The processor 30 may receive an input of a detection area designating a damaged area or a specific object to be monitored within a POI, such as a road or facility, and set the detection area on the PCD map based on GPS data and display the set detection area.

In this case, the processor 30 may visually distinguish the detection areas according to the detection importance of the detection areas such that managers may easily identify the detection areas.

For example, a damaged area may be marked in red, and the position of an important object may be marked in yellow.

Afterwards, in order to identify the current position of the moving object in real time, the processor 30 may collect PCD from the LiDAR sensor 2 as shown in FIG. 2B and match the PCD with the PCD map to calculate and estimate the position of the moving object.

In this case, the processor 30 may calculate the current position of the moving object by comparing and matching the PCD with the PCD map based on an iterative closest point (ICP) algorithm, which is a matching algorithm.

When the moving object comes within a set distance of the POI, the processor 30 may match the PCD with the PCD map through SLAM feature matching as shown in FIG. 2C so that the current position of the moving object may be accurately estimated.

Meanwhile, the processor 30 may also construct a 3D environment map of the corresponding position through PCD input from the LiDAR sensor 2 of the moving object.

After estimating the current position of the moving object as described above, when the detection area is included in the field of view of the optical image based on the distance between the position of the moving object and the detection area as shown in FIG. 2D, the processor 30 may project 3D PCD onto the optical image of the optical camera for monitoring and provide the projection result visually through the input/output module 10.

In this case, since the LiDAR sensor 2 and the optical camera 4 mounted on the moving object have completed calibration, the 3D PCD collected from the LiDAR sensor 2 may be projected onto the optical image.

Therefore, a manager may check the detection area in the optical image visually provided through the input/output module 10 as shown in FIG. 2E. For example, since a damaged road section or damaged structure may be visually emphasized and displayed in the optical image, the manager may intuitively identify problems and respond immediately.

In addition, the processor 30 may classify the type of the object through a classification algorithm that has been trained on objects in the detection area and define and provide the type of damage.

In addition, the processor 30 may analyze the degree of change in the detection area and provide the analyzed degree of change in the detection area.

That is, the processor 30 stores pixel-based RGB values of the optical image visualizing the detection area and pixel-based position coordinates of the 3D PCD in the database 40 in time series. When the moving object repeatedly travels through the POI as described above, time-series data for the detection area accumulates, and the processor 30 may analyze the degree of change such as changes in the damage state of the detection area and deformation of specific objects.

For example, main analysis content may include time-series data of climate statistics and the range of bryophytes such as moss found through image segmentation, and the analysis may be performed by converting the degree of change of walls and buildings into time-series data.

By analyzing the degree of change in the detection area as described above, a manager may easily identify state changes in the detection area, set priorities for maintenance operations based on the analysis results, and detect new damage or problems through continuous monitoring.

As described above, the apparatus for detecting a change in a POI according to an embodiment of the present invention monitors a damaged area or specific object within a POI generated based on 3D PCD utilizing a LiDAR sensor mounted on a moving object, detects a change or damage in a detection area in real time, and projects the detected result onto an optical image to visually provide the detected result, thereby supporting rapid decision-making and maintenance operations and enabling maintenance planning through time-series analysis of the detection area.

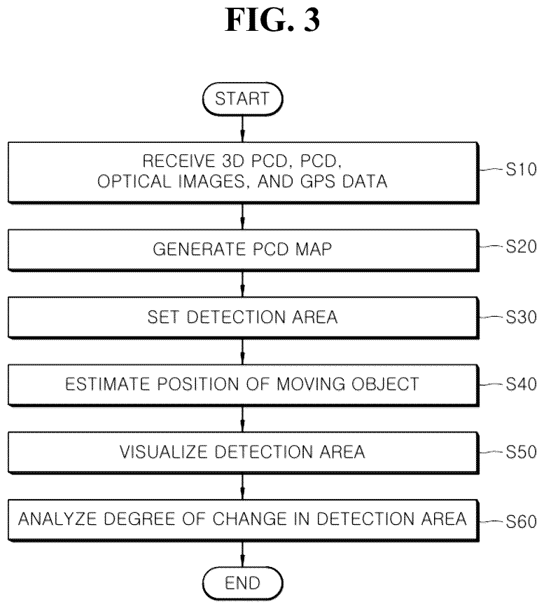

FIG. 3 is a flowchart for describing a method of detecting a change in a POI according to an embodiment of the present invention.

Referring to FIG. 3, in a method of detecting a change in a POI according to an embodiment of the present invention, first, a processor 30 executes the execution program stored in a memory 20 and then receives 3D PCD, PCD, optical images, and GPS data in a wired or wireless manner from a LiDAR sensor, an optical camera, and a GPS receiver installed on a moving object (S10).

After receiving the 3D PCD scanned in three dimensions of the surrounding environment from the LiDAR sensor in operation S10, the processor 30 applies an SLAM algorithm to generate a PCD map as shown in FIG. 2A (S20).

After generating the PCD map in operation S20, the processor 30 receives an input of a detection area designating a damaged area or a specific object to be monitored within a POI, such as a road or facility, sets the detection area on the PCD map based on GPS data, and displays the set detection area (S30).

In this case, the processor 30 may visually distinguish the detection areas according to the detection importance of the detection areas such that managers may easily identify the detection areas.

For example, a damaged area may be marked in red, and the position of an important object may be marked in yellow.

Afterwards, in order to identify the current position of the moving object in real time, the processor 30 may collect PCD from the LiDAR sensor 2 as shown in FIG. 2B and match the PCD with the PCD map to calculate and estimate the position of the moving object (S40).

In this case, the processor 30 may calculate the current position of the moving object by comparing and matching the PCD with the PCD map based on an ICP algorithm, which is a matching algorithm.

Then, when the moving object comes within a set distance of the POI, the processor 30 may match the PCD with the PCD map through SLAM feature matching as shown in FIG. 2C so that the current position of the moving object may be accurately estimated.

After estimating the current position of the moving object in operation S40, when the detection area is included in the field of view of the optical image based on the distance between the position of the moving object and the detection area as shown in FIG. 2D, the processor 30 may project 3D PCD onto the optical image of the optical camera 4 to visualize the 3D PCD and provide the visualization result through the input/output module 10 (S50).

Therefore, a manager may check the detection area in the optical image visually provided through the input/output module 10 as shown in FIG. 2E. For example, since a damaged road section or damaged structure may be visually emphasized and displayed in the optical image, the manager may intuitively identify problems and respond immediately.

In addition, the processor 30 may classify the type of the object through a classification algorithm that has been trained on objects in the detection area and define and provide the type of damage.

While visualizing and providing the detection area in operation S50, the processor 30 may analyze the degree of change in the detection area (S60).

That is, the processor 30 stores pixel-based RGB values of the optical image visualizing the detection area and pixel-based position coordinates of the 3D PCD in the database 40 in time series. When the moving object repeatedly travels through the POI as described above, time-series data for the detection area accumulates, and the processor 30 may analyze the degree of change such as changes in the damage state of the detection area and deformation of specific objects.

For example, main analysis content may include time-series data of climate statistics and the range of bryophytes such as moss found through image segmentation, and the analysis may be performed by converting the degree of change of walls and buildings into time-series data.

By analyzing the degree of change in the detection area as described above, a manager may easily identify state changes in the detection area, set priorities for maintenance operations based on the analysis results, and detect new damage or problems through continuous monitoring.

As described above, the method of detecting a change in a POI according to an embodiment of the present invention includes monitoring a damaged area or specific object within a POI generated based on 3D PCD utilizing a LiDAR sensor mounted on a moving object, detecting a change or damage in a detection area in real time, and projecting the detected result onto an optical image to visually provide the detected, thereby supporting rapid decision-making and maintenance operations and enabling maintenance planning through time-series analysis of the detection area.

As is apparent from the above, according to the apparatus and method for detecting a change in a POI according to the present invention, a damaged area or specific object within a POI generated based on 3D PCD is monitored utilizing a LiDAR sensor mounted on a moving object, a change or damage in a detection area is detected in real time, and the detected result is projected onto an optical image to visually provide the detected result, thereby supporting rapid decision-making and maintenance operations and enabling maintenance planning through time-series analysis of the detection area.

Although the present invention has been described with reference to embodiments illustrated in the drawings, the embodiments disclosed above should be construed as being illustrative rather than limiting the present invention, and those skilled in the art should appreciate that various substitutions, modifications, and changes are possible without departing from the scope and spirit of the present invention. Therefore, the scope of the present invention is defined by the appended claims of the present invention.

What is claimed is:

1. An apparatus for detecting a change in a point of interest (POI), the apparatus comprising:
an input/output module that receives 3D point cloud data (PCD), PCD, optical images, and global positioning system (GPS) data from a LiDAR sensor, an optical camera, and a GPS receiver installed on a moving object and outputs a detection result;
a database; and
a processor operatively coupled to the input/output module and the database,
wherein the processor is configured to:
generate a PCD map based on the 3D PCD input from the LiDAR sensor;
receive a detection area within a POI and set the detection area on the PCD map based on the GPS data;
collect the PCD from the LiDAR sensor, estimate a position of the moving object, and project the 3D PCD onto the optical image based on a distance between the position of the moving object and the detection area to visually provide a projection result; and
analyze a degree of change in the detection area.

2. The apparatus of claim 1, wherein the processor applies a simultaneous localization and mapping (SLAM) algorithm to generate the PCD map through the 3D PCD.

3. The apparatus of claim 1, wherein the processor sets the detection area to be visually distinguished according to a detection importance thereof.

4. The apparatus of claim 1, wherein the processor matches the PCD with the PCD map through SLAM feature matching when the moving object comes within a set distance of the POI to estimate a current position of the moving object.

5. The apparatus of claim 1, wherein the processor projects the 3D PCD onto the optical image when the detection area is included in the optical image, to visualize the 3D PCD.

6. The apparatus of claim 1, wherein the processor classifies a type of an object through a classification algorithm that has been trained on objects in the detection area and provides a result of the classification.

7. The apparatus of claim 1, wherein the processor stores pixel-based RGB values of the visualized optical image and pixel-based position coordinates of the 3D PCD in the database in time series and analyzes the degree of change in the detection area.

8. A method of detecting a change in a point of interest (POI), the method comprising:
generating, by a processor, a point cloud data (PCD) map based on 3D PCD input from a LiDAR sensor;
receiving, by the processor, a detection area within a POI and setting the detection area on the PCD map based on global positioning system (GPS) data;
collecting, by the processor, PCD from the LiDAR sensor and estimating a position of a moving object;
projecting the 3D PCD onto an optical image based on a distance between the position of the moving object and the detection area and visually providing a projection result; and
analyzing a degree of change in the detection area.

9. The method of claim 8, wherein the generating of the PCD map includes applying, by the processor, a simultaneous localization and mapping (SLAM) algorithm to generate the PCD map through the 3D PCD.

10. The method of claim 8, wherein the setting of the detection area includes setting the detection area to be visually distinguished according to a detection importance thereof.

11. The method of claim 8, wherein the estimating of the position of the moving object includes matching, by the processor, the PCD and the PCD map through SLAM feature matching when the moving object comes within a set distance of the POI to estimate a current position of the moving object.

12. The method of claim 8, wherein the providing of a projection result visually includes projecting, by the processor, the 3D PCD onto the optical image when the detection area is included in the optical image, to visualize the 3D PCD.

13. The method of claim 8, wherein the providing of a projection result visually includes classifying, by the processor, a type of an object through a classification algorithm that has been trained on objects in the detection area and providing the classified type of the object.

14. The method of claim 8, wherein the analyzing of the degree of change in the detection area includes storing, by the processor, pixel-based RGB values of the visualized optical image and pixel-based position coordinates of the 3D PCD in a database in time series, and analyzing the degree of change in the detection area.
